(19) United States
(12) Patent Application Publication
(10) Pub. No.: US 2010/0196053 A1
(43) Pub. Date: Aug. 5, 2010

(54) Exposure Head and Image Forming Apparatus

(75) Inventors: Hiroshi TANAKA, Matsumoto-shi (JP); Ken IKUMA, Suwa-shi (JP)

Correspondence Address: Hogan Lovells US LLP, 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/645,268

(22) Filed: Dec. 22, 2009

(30) Foreign Application Priority Data
Feb. 3, 2009 (JP) 2009-022219

(51) Int. Cl. G03G 15/04

(52) U.S. Cl. 399/220

(57) ABSTRACT

An exposure head includes first and second light-emitting element rows formed by disposing light-emitting elements in a first direction on a light-transmitting substrate. A first photosensor is disposed at a first side in a second direction perpendicular to the first direction on the light-transmitting substrate to receive light emitted from the light-emitting elements of the first and second light-emitting element rows. A second photosensor is disposed in the second direction at a second side opposite to the first side on the light-transmitting substrate to receive light emitted from the light-emitting elements of the first and second light-emitting element rows. An image-forming optical system forms an image with light emitted from the light-emitting elements.

### CROSS-REFERENCE TO RELATED APPLICATIONS

This application claims the benefit of priority under 35 USC 119 of Japanese application no. 2009-022219, filed on Feb. 3, 2009, which is incorporated herein by reference.

### BACKGROUND

1. Technical Field

This invention relates to an electro-photographic type image forming apparatus, and more particularly, to an exposure head for forming an electrostatic latent image on a latent image container and an image forming apparatus using the exposure head.

2. Related Art

In related art, in an electro-photographic type image forming apparatus such as an electro-photographic apparatus, an electrostatic copier, a printer, and a facsimile apparatus, a laser scan optical system is generally used as a unit of writing light on a latent image container. JP-A-2000-238333 discloses an exposure head that is configured by disposing organic EL light-emitting elements and photosensors for detecting light amounts thereof on the same substrate in an array shape so as to prevent a non-uniformity in concentration due to a decrease in emitted light amount. JP-A-2002-127489 discloses a technique of removing a non-uniformity in the concentration of an image by separately correcting non-uniformity in the light amount of each light-emitting element by using light-emitting elements that are arranged one-dimensionally on a transparent substrate and a photosensor that is formed on a surface other than the surface of the transparent substrate, on which the light-emitting elements are formed, to receive a portion of straightly emitted light that is irradiated from the light-emitting elements to the transparent substrate.

JP-A-2004-82330 discloses a technique in which, in order to correct a non-uniformity in the light amount of each light-emitting element, a photosensor is disposed on one of two surfaces of a transparent substrate at a position where the light beam that is to be totally reflected in the transparent substrate is guided to the photosensor, so that the light amount of each of the light-emitting elements is efficiently detected so as to increase the accuracy of light amount detection.

As disclosed in JP-A-2000-238333, JP-A-2002-127489, and JP-A-2004-62330, it is well-known that the photosensor is disposed on the substrate, on which the light-emitting elements are disposed, and that correction is performed on each of the light-emitting elements in order to remove non-uniformity in light amount caused by individual product differences between the light-emitting elements or by long-term change. Particularly, in JP-A-2004-82330, like the accuracy of light amount detection is increased by improving the light amount efficiency from the light-emitting elements to the photosensors, the accuracy of the light amount detection is increased by improving the SN ratio of the light amount detected by the photosensor, so that non-uniformity in concentration of the image can be removed.

As disclosed in JP-A-2000-238333 and JP-A-2002-127489, in other to improve the SN ratio of the light amounts detected by the photosensors, the photosensors in correspondence to the light-emitting elements are preferably disposed close to the light-emitting elements. However, since the number of light-emitting elements in the exposure head has recently tended to increase in accordance with high resolution, the number of the corresponding photosensors has also increased. Therefore, production costs are increased. In addition, in JP-A-2000-238333 and JP-A-2002-127489, since the photosensors are collectively disposed on one side for the light-emitting element arrangement, a space for disposing various circuits for driving the photosensors cannot be, easily prepared on the same substrate on which the photosensors are disposed. As a result, the exposure head has a large size.

FIG. 14 of JP-A-2004-82330 shows an arrangement of photosensors, in which two rows of light-emitting units are disposed in a zigzag shape on a glass substrate, and two photosensor groups, each of which includes four photosensors, are disposed at two sides in the sub scan direction with the light-emitting units of the glass substrate interposed therebetween. The detected value of the photosensor that is closest to the light-emitting units is used for correction. According to this configuration, the signal components in the light amount can be increased. However, with respect to the arrangement of the light-emitting units and the photosensors, in the case where the detected value of the photosensor that is closest to the light-emitting units is used for correction, the light amounts of adjacent light-emitting units may be detected by different photosensors. Therefore, a light amount detection error caused by a difference in circuit configuration between the photosensors may occur between adjacent light-emitting units, so that the correction may not be accurately performed.

Particularly, with respect to a recently developed exposure head using a microlens array, in which two or three rows of light-emitting element groups constructed with a plurality of light-emitting elements are arranged in a zigzag shape, if the arrangement of JP-A-2004-82330 is employed, the light of the light-emitting element groups is received by different photosensors. Thus, non-uniformity in light amount occurs between adjacent light-emitting element groups. Therefore, image non-uniformity in the forming image is visually noticeable.

### SUMMARY

An advantage of some aspects of the invention is to suppress non-uniformity in the light amount detected in an exposure head, in which a plurality of rows of light-emitting element groups are arranged, such as an exposure head using a microlens array. In addition, another advantage is to implement a small-sized exposure head and to reduce costs.

According to an aspect of the invention, an exposure head includes a light-transmitting substrate; a first light-emitting element row that is formed by disposing light-emitting elements in a first direction on the light-transmitting substrate; a second light-emitting element row that is formed by disposing light-emitting elements in the first direction and that is different from the first light-emitting element row; a first photosensor that is disposed at a first side in a second direction perpendicular to the first direction on the light-transmitting substrate to receive light emitted from the light-emitting elements of the first and second light-emitting element rows; a second photosensor that is disposed in the second direction at a second side opposite to the first side on the light-transmitting substrate to receive light emitted from the light-emitting elements of the first and second light-emitting element rows; and an image-forming optical system that forms an image with the light emitted from the light-emitting elements.

According to another aspect of the invention, an exposure head includes a light-transmitting substrate; a first light-emitting element row that is formed by disposing light-emitting elements in a first direction on the light-transmitting substrate; a second light-emitting element row that is formed by disposing light-emitting elements in the first direction and that is different from the first light-emitting element row; a third light-emitting element row that is formed by disposing light-emitting elements in the first direction and that is different from the first and second light-emitting element rows; a first photosensor that is disposed at a first side in a second direction perpendicular to the first direction on the light-transmitting substrate to receive light emitted from the light-emitting elements of the first, second and third light-emitting element rows; a second photosensor that is disposed in the second direction at a second side opposite to the first side on the light-transmitting substrate to receive light emitted from the light-emitting elements of the first, second and third light-emitting element rows; and an image-forming optical system that forms an image with the light emitted from the light-emitting elements.

In the exposure head according to the present invention, the first and second photosensors may be partially overlapped with each other as viewed from the second direction.

According to another aspect of the invention, an image forming apparatus includes an exposure head including a light-transmitting substrate, a first light-emitting element row that is formed by disposing light-emitting elements in a first direction on the light-transmitting substrate; a second light-emitting element row that is formed by disposing light-emitting elements in the first direction and that is different from the first light-emitting element row, a first photosensor that is disposed at a first side in a second direction perpendicular to the first direction on the light-transmitting substrate to receive light emitted from the light-emitting elements of the first and second light-emitting element rows, a second photosensor that is disposed in the second direction at a second side opposite to the first side on the light-transmitting substrate to receive light emitted from the light-emitting elements of the first and second light-emitting element rows, and an image-forming optical system that forms an image with the light emitted from the light-emitting elements; a latent image container on which a latent image is formed by the exposure head; and a developing unit that develops the latent image formed on the latent image container.

According to another aspect of the invention, an image forming apparatus includes an exposure head including a light-transmitting substrate, a first light-emitting element row that is formed by disposing light-emitting elements in a first direction on the light-transmitting substrate, a second light-emitting element row that is formed by disposing light-emitting elements in the first direction and that is different from the first light-emitting element row, a third light-emitting element row that is formed by disposing light-emitting elements in the first direction and that is different from the first and second light-emitting element rows, a first photosensor that is disposed at a first side in a second direction perpendicular to the first direction on the light-transmitting substrate to receive light emitted from the light-emitting elements of the first, second and third light-emitting element rows, a second photosensor that is disposed in the second direction at a second side opposite to the first side on the light-transmitting substrate to receive light emitted from the light-emitting elements of the first, second and third light-emitting element rows, and an image-forming optical system that forms an image with the light emitted from the light-emitting elements; a latent image container on which a latent image is formed by the exposure head; and a developing unit that develops the latent image formed on the latent image container.

### BRIEF DESCRIPTION OF THE DRAWINGS

The invention will be described with reference to the accompanying drawings, wherein like numbers reference like elements.

FIG. 1 is a cross-sectional view of an image forming apparatus according to an embodiment of the invention.

FIG. 2 is a perspective view of an exposure head according to the embodiment of the invention.

FIG. 3 is a cross-sectional view of an exposure head according to the embodiment of the invention.

FIG. 4 is a view showing an arrangement of components on a glass substrate according to the embodiment of the invention.

FIG. 5 is a view showing a control configuration for performing a correction process on an exposure head according to the embodiment of the invention.

FIG. 6 is a view showing an arrangement of photosensors according to the embodiment of the invention.

FIG. 7 is a view showing a relation between positions of photosensors and light-emitting element groups according to a first embodiment of the invention.

FIG. 8 is a view showing a relation between positions of photosensors and light-emitting element groups according to a second embodiment of the invention.

FIG. 9 is a view showing output characteristics of a photosensor according to the second embodiment of the invention.

FIG. 10 is a view showing a relation between positions of photosensors and light-emitting element groups according to a third embodiment of the invention.

FIG. 11 is a view showing output characteristics of a photosensor according to the third embodiment of the invention.

FIG. 12 is a view showing an arrangement of photosensors according to a fourth embodiment of the invention.

### DESCRIPTION OF EXEMPLARY EMBODIMENTS

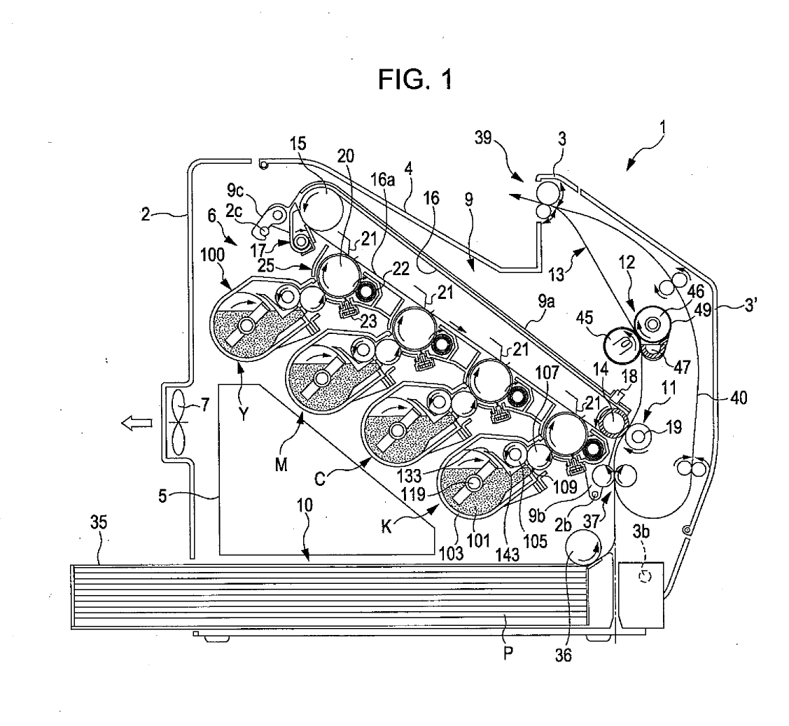

Embodiments of the invention are now described with reference the accompanying drawings. FIG. 1 is a cross-sectional view of a tandem type image forming apparatus 1, on which exposure heads are mounted, according to an embodiment of the invention. The image forming apparatus 1 includes a case body 2, a first openable member 3 that is openably mounted on a front surface of the case body 2, and a second openable member 4 (used as a discharge tray) that is openably mounted on an upper surface of the case body 2.

The first openable member 3 has an opening cover 3′ that is openably mounted on the front surface of the case body 2. In the inner portion of the case body 2, an electrical component box 5 containing a power source circuit substrate and a control circuit substrate, an image forming unit 6, a blast fan 7, a transfer belt unit 9, and a feeding unit 10 are disposed. In addition, in the inner portion of the first openable member 3, a secondary transfer unit 11, a fixing unit 12, and a recording media transport unit 13 are disposed.

The transfer belt unit 9 includes a driving roller 14 that is driven to rotate by a driving source, a driven roller 15 that is disposed at a position diagonally angled upward from the driving roller 14, and an intermediate transfer belt 16 that is suspended by the two rollers 14 and 15 and driven to rotate in the arrow direction (in FIG. 1, an abutting surface of the primary transfer member 21 is in the downward direction) by the driving roller 14 and the driven roller 15. The cleaning unit 17 is abutted on a surface of the intermediate transfer belt 16.

The image forming unit 6 includes image forming stations Y (yellow), M (magenta), C (cyan), and K (black) that form images in a plurality of different colors (in the embodiment, four colors). Each of the image forming stations Y, M, C, and K includes a drum-shaped photoreceptor (latent image container) 20, a charging unit 22, an exposure head 23, and a developing apparatus 100. A primary transfer member 21 constructed with a leaf spring electrode is abutted on the photoreceptor 20 of each of the image forming stations Y, M, C, and K corresponding to the colors by an elastic force of the primary transfer member 21, and a transfer bias is applied to the primary transfer member 21. A test pattern sensor 18 is disposed in the vicinity of the driving roller 14.

The photoreceptor (latent image container) 20 is driven to rotate in the arrow direction (clockwise). The charging unit 22 is constructed with a conductive brush roller connected to a high voltage generating source to allow a brush circumference to rotate in the state of abutting on the photoreceptor (latent image container) 20 in the reverse direction (counterclockwise) with respect to the photoreceptor (latent image container) 20 at a circumferential speed two or three times that of the photoreceptor (latent image container) 20, so that a surface of the photoreceptor (latent image container) 20 can be charged uniformly.

As an exposure unit, the exposure head 23 employs an organic EL light-emitting element array, in which a plurality of rows of organic EL light-emitting elements are arranged in an array shape in the axis direction (main scan direction) and the width direction (sub scan direction) of the photoreceptor (latent image container) 20. Since the exposure head 23 employing the organic EL light-emitting elements has a shorter light path length and a smaller size than a laser scan optical system, the exposure head 23 can be disposed in the vicinity of the photoreceptor (latent image container) 20, so that there is an advantage in that the entire apparatus can be implemented to have a small size. In addition, unlike the laser scan optical system, since the exposure head, 23 does not have a large number of parts, the configuration thereof can be simplified. The light-emitting element used for the exposure head according to the invention is not limited to an organic EL light-emitting element, and various types of light-emitting elements such as LEDs may be employed. In addition, in each of the image forming stations Y, M, C, and K, the photoreceptor (latent image container) 20, the charging unit 22, and the exposure head 23 are configured to be detachable as one photoreceptor unit 25, so that maintenance can be conveniently performed.

Next, the developing apparatus 100 is described in detail by exemplifying the image forming station K. The developing apparatus 100 includes a case 103 that contains toner (a hatched portion in FIG. 1), a toner containing unit 101 that is formed in the inner portion of the case 103, an agitator 119 that is disposed in the inner portion of the toner containing unit 101, and a toner guide member 133 that is formed to partition in an upper portion of the toner containing unit 101. In addition, the developing apparatus 100 includes a supply roller 105 that is disposed above the toner guide member 133, an abutting portion 143 that is disposed to the toner guide member 133 to abut on the supply roller 105, a developing roller 107 that is disposed to abut on the toner guide member 133 and the latent image container 20, and a regulating blade 109 that is disposed to abut on the developing roller 107.

Next, various members that are disposed along a transport path of the recording medium P are described. The feeding unit 10 includes a feed cassette 35 that contains the recording medium P and a pick-up roller 36 that feeds the recording medium P sheet by sheet from the feed cassette 35. In the inner portion of the first openable member 3, a register roller pair 37 that regulates a timing of feeding the recording medium P to the secondary transfer unit, a secondary transfer unit 11 that presses the facing driving roller 19 on the intermediate transfer belt 16 and performs the secondary transfer, a fixing unit 12, a recording medium transport path 13, a discharge roller pair 39, and a double-sided printing transport path 40 are disposed. In the case where both sides of the recording medium P are to be printed, after one side is printed, the recording medium P is transported to the double-sided printing transport path 40 by rotating the discharge roller pair 39 in the reverse direction, and the recording medium P is transported again from the register roller pair 37 to the recording medium transport path 13, so that the rear side is printed.

The fixing unit 12 includes a heating roller 45 embedded with a heater such as a halogen heater, a pressing roller 46 that presses the heating roller 45, a belt suspension member 47 that is swingably disposed to the pressing roller 46, and a heat-resistant belt 49 that is suspended between the pressing roller 46 and the belt suspension member 47. A color image that is secondarily transferred to the recording medium P is fixed on the recording medium P at a predetermined temperature in a nip part that is formed by the heating roller 45 and the heat-resistant belt 49.

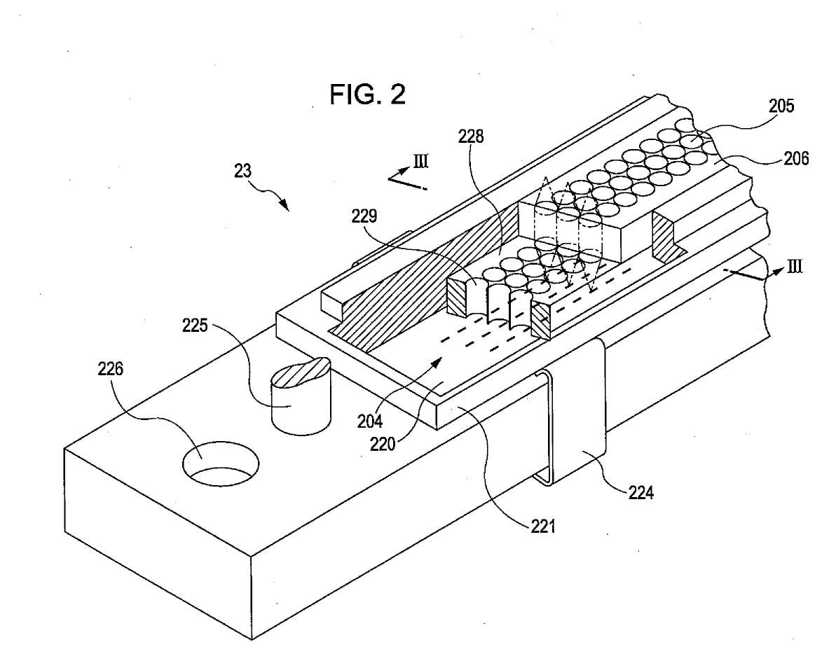

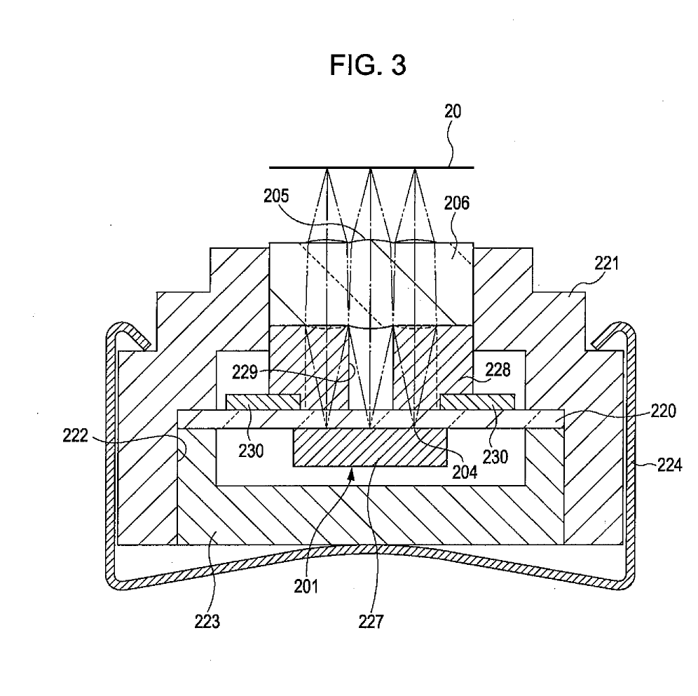

Next, a configuration of the exposure head according to the invention is described. FIG. 2 is a partially cutaway perspective view of the exposure head. FIG. 3 is a sub scan direction (width direction) cross-sectional view of the exposure head.

In FIG. 2, reference numerals 204, 205, 206, 220, 221, 222, 224, 225, 226, 227, 228, and 229 denote, respectively, a light-emitting element group, a microlens, a microlens array, a glass substrate as a light-transmitting substrate, a case, a receiving hole, a fixing clamp, a positioning pin, a screw inserting hole, a seal member, a light-shielding member, and a through hole.

The light-emitting element group 204 is formed as a light-emitting element pattern where light-emitting elements are arranged in an array shape in the main scan direction (elongated direction) and the sub scan direction (width direction) on the glass substrate 220. The light-emitting element group 204 is contained in the case 221 that is installed in an elongated shape in the main scan direction.

In order to accurately position the exposure head 23 with respect to each of the photoreceptors (latent image containers) 20, a positioning pin 225 and a screw inserting hole 226 are provided. The positioning pin 225 is inserted into the positioning hole that is formed at the opposite side. Fixing screws are inserted into the screw inserting holes 226 that are formed at two end portions of the elongated case 221, so that the exposure head 23 is fixed at a predetermined position of the one side of image forming apparatus 1.

FIG. 3 is a sub scan direction cross-sectional view of the exposure head 23, in the configuration of FIG. 2 is partially shown. Herein, the sub scan direction is perpendicular to the rotation axis of the latent image container 20, and the main scan direction is parallel to the rotation axis of the latent image container 20. The light-emitting element groups 204 are mounted on the lower surface of the glass substrate 220, and the photosensors 230 for performing the light amount correction are mounted on the upper surface of the glass substrate 220. The output light from each light-emitting element in the light-emitting element group 204 is irradiated through the microlens 205 disposed in front of the light-emitting elements on the photoreceptor (latent image container) 20. The case 221 shields the periphery of the glass substrate 220, and the side facing the photoreceptor (latent image container) 20 is opened. The seal member 227 prevents the output light from radiating toward the side opposite of the irradiated surface of the photoreceptor 20, so that light emission efficiency is increased. The glass substrate 220 is inserted into the receiving hole 222 that is formed in the elongated case 221. Next, the glass substrate 220 is covered by the rear cover 223, and the resulting product is fixed by the fixing clamp 224.

The light-shielding member 228, in which through holes 229 penetrate in alignment with the light-emitting element groups 204 of the array of light-emitting elements, is disposed on the upper surface side of the glass substrate 220. The microlens array 206, in which the microlenses 205 are installed at positions corresponding to the through holes 229, is disposed on the upper surface side of the light-shielding member 228. The optical axis of each of the microlenses 205 is disposed at an approximate center of the light-emitting element group 204.

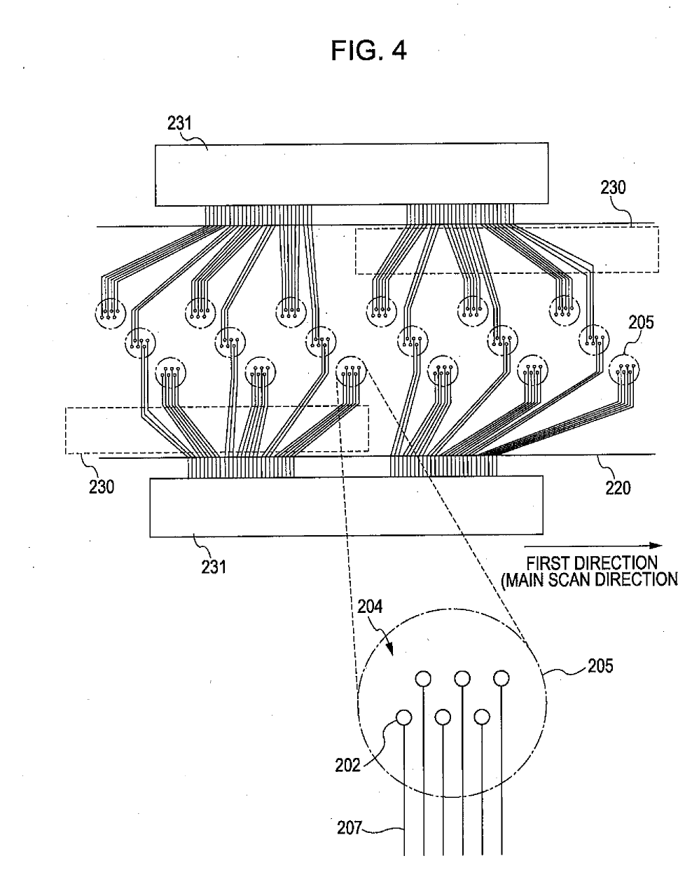

FIG. 4 shows an arrangement of components of the exposure head on the glass substrate 220, in which a portion of the glass substrate 220 is shown in the main scan direction (first direction). In FIG. 4, the portion surrounded by a one-dot dashed line shows a relation of the positions of the microlenses 205 with respect to the glass substrate 220. An enlarged view of one of the microlenses is shown in the right lower portion of FIG. 4. The light-emitting element group 204 that is constructed as a group of the light-emitting elements 202 is disposed in the portion where the microlens 205 is positioned on the glass substrate 220.

Three light-emitting elements 202 are arranged in the main scan direction (first direction) to form each light-emitting element row, and two light-emitting element rows are formed in the sub scan direction, so that one light-emitting element group 204 is formed. A plurality of the light-emitting element groups 204 are disposed in the main scan direction and the sub scan direction, so that the light-emitting element pattern is formed. The number of light-emitting elements 202 in the light-emitting element group 204 is not limited to this embodiment, and any suitable number can be provided. For example, several tens of light-emitting elements 202 may be provided in one light-emitting element group 204. In addition, the arrangement of light-emitting elements 202 in the light-emitting element group 204 is not limited to a 3×2 (row×row) arrangement, and may be suitably configured as any n×m (n and m are integers of 1 or more) arrangement.

The main scan direction front end portions of the light-emitting element groups 204 are designed to be shifted in the sub scan direction, so that the light-emitting element groups 204 can be arranged in a zigzag shape. In FIG. 4, three rows of the light-emitting element groups 204 are arranged in the sub scan direction. The number of rows of the light-emitting element groups 204 is not limited to three, and two or more rows may be provided as a suitable number of the rows if necessary.

The light-emitting element 202 is connected to a driver 231 through a wire 207. In this embodiment, the light-emitting elements 202 are separately driven by different drivers 231 that are disposed at two sides partitioned by the center of the glass substrate 220. In this manner, since the drivers 231 are provided at the two sides and wiring is performed, even in the case where a large number of the light-emitting elements 202 are driven, the wiring configuration can be simplified, and accurate wiring can be implemented. Photodiodes or the like may be used as the photosensors 230 shown by dotted rectangles. The photosensors 230 are disposed on the surface opposite to the surface on which the light-emitting elements 202 are disposed.

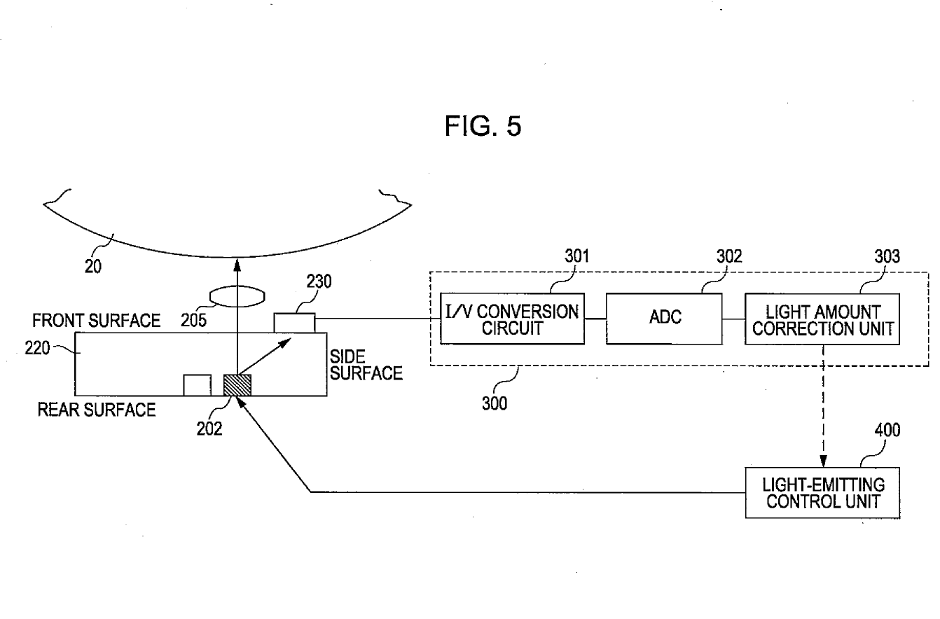

FIG. 5 shows a control configuration for performing a correction process on the exposure head by using the photosensor 230. Similarly to FIG. 3, in a sub scan direction cross-sectional view of the exposure head, the latent image container 20 that is positioned to face the glass substrate 220 is shown. During the normal operation of printing characters in the image forming apparatus, an output light from the light-emitting element 202 disposed on the rear surface of the glass substrate 220 is irradiated on a surface of the latent image container 20 through the microlens 205, so that an electrostatic latent image is formed. On the other hand, at the time of the correction process for each light-emitting element 202, that is, at the time of calibration, the output light emitted from the light-emitting element 202 is detected by the photosensor 230.

The light-emitting elements 202 are separately controlled to turn on and off by a light amount detection unit 300 that is configured to include the driver 231. The photosensor 230 is connected to the light amount detection unit 300 including an I/V conversion circuit 301 that converts a current value output according to the detected light amount into a voltage value, an ADC 302 that converts the converted voltage value into a digital value, and a light amount correction unit 303 that performs the correction process on the control of turning on and off the light-emitting element 202 based on the digital value of the detected light amount. In this embodiment, the photosensor 230 is disposed on the surface (the front surface of the glass substrate 220) opposite to the surface of the glass substrate 220, on which the light-emitting elements 202 are disposed. Alternatively, the photosensor 230 may be disposed on the rear or side surface of the glass substrate 220. In the case where the photosensor 230 is disposed on the rear surface of the glass substrate 220, the photosensor 230 detects a light reflected from the light-emitting element 202.

An example of the correction process of correcting a variation in the output light among the light-emitting elements 202 due to the long-term deterioration or the like to prevent the non-uniformity in concentration of the forming image is now described. First, at the time of shipment of the exposure head, the light amount of each light-emitting element 202, which is exposed from each light-emitting element 202 through the microlens 205 on the latent image container 20, is detected. For the operation, the exposure head is installed in an inspection jig. The inspection jig is provided with a light amount detector that detects the output light emitted from the light-emitting elements 202 at the position where the latent image container 20 is disposed. As the light amount detector, one detector may detect the light amount emitted from each of the light-emitting elements 202 while the detector is allowed to be moved. Alternatively, as the light amount detector, detectors in the same number as the light-emitting elements 202 may be disposed. Next, the light-emitting elements 202 are controlled to sequentially emit light by the light-emitting control unit 400. A value Pgn (the suffix n denotes an n-th light-emitting element 202) that is detected by the light amount detector in the inspection jig and a value Phn that is detected by the photosensor 230 are obtained for each light-emitting element. Next, a correction coefficient Pgn/Phn for each light-emitting element 202 is calculated.

The obtained correction coefficient Pgn/Phn is stored in the light amount correction unit 303 or in a memory of the light-emitting control unit 400. The correction process for each light-emitting element 202 is performed by using the correction coefficient Pgn/Phn stored in the memory. An example of the method thereof is now described. Individual light-emitting elements 202 in the exposure head are controlled to emit light based on the data of initial values stored in advance by the light-emitting control unit 400, and the measured values are measured by the photosensors 230. The light amount at the upper surface position of each of the light-emitting elements 202 is calculated by multiplying the measured values with the correction coefficient Pgn/Phn stored in the memory.

The calculated light amount is compared with a target light amount, and a current flowing through the light-emitting elements 202 or the like is controlled based on a difference between the light amounts so that the calculated light amount is equal to the target light amount. Therefore, the emitted light amount of each of the light-emitting elements 202 is corrected so as to be equal to the target light amount. The correction process is repetitively performed on all the light-emitting elements 202, so that the light amounts of all the light-emitting elements are adjusted to be equal to the target value. The correction process may be performed at a suitable timing such as just after the image forming apparatus is powered on, before the printing starts, or when a predetermined number of sheets are printed.

In addition to the aforementioned process, as an example of the correction process, a suitable number of reference light-emitting elements, of which light amounts are adjusted as a predetermined light amount in advance, may be provided in the vicinity of each of the light-emitting elements 202 in FIG. 4, and the light amount correction of each of the light-emitting elements 202 may be performed based on the comparison with the reference light-emitting elements. Since the reference light-emitting element is not used for a normal printing process, aging deterioration in the reference light-emitting element due to use does not occur. Therefore, the light amount of each of the light-emitting elements 202 can be uniform by allowing the light amount to be equal to that of the reference light-emitting element. In this case, the reference light-emitting element is preferably provided to each of the light-emitting element groups 204.

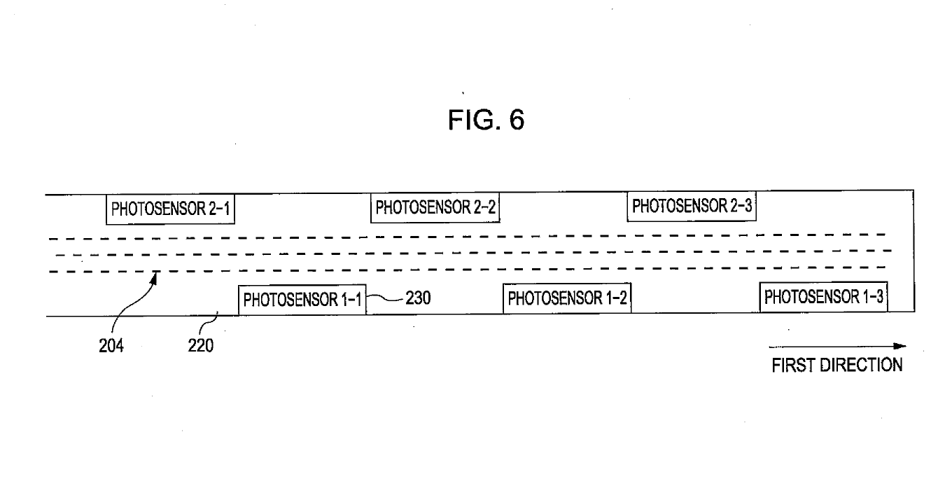

The light amount of each of the light-emitting elements 202 is allowed to be uniform by the above various correction processes, so that non-uniformity in concentration of the forming image is suppressed. Next, the arrangement of the photosensors 230 used for the correction process is described. FIG. 6 shows an arrangement of the photosensors 230 on the glass substrate 220. As described in FIG. 4, a light-emitting element pattern, in which three rows of the light-emitting element groups 204 are arranged in the first direction (main scan direction), is formed on the glass substrate 220. A plurality of the photosensors 230 are disposed at the first side and the second side perpendicular to the first direction so as to face the light-emitting element pattern. In addition, the photosensors 230 are alternately disposed at the first side and the second side in the first direction, that is, alternately staggered as shown in FIG. 6. According to the configuration in which a plurality of the photosensors 230 are disposed in the vicinity of the light-emitting elements, an SN ratio of output signals of the photosensors 230 is improved. In addition, a space is provided between the photosensors 230 at the two sides that can be used as the installation site of the circuits of the light amount detection unit 300 that detects the light amounts of the photosensors 230, so that the exposure head can have a small size.

### First Embodiment

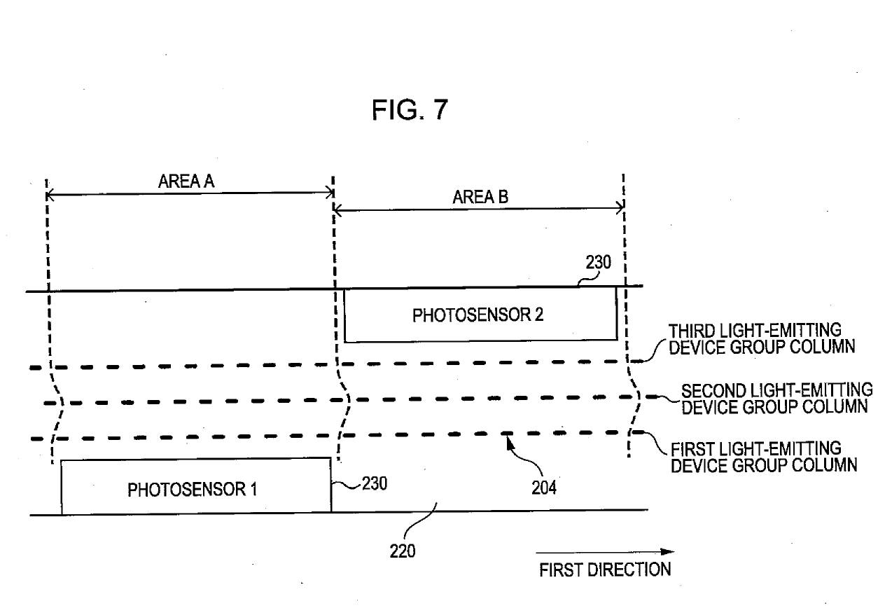

An arrangement of the photosensors 230 according to a first embodiment of the invention is described with reference to FIG. 7. FIG. 7 is a partial enlarged view of FIG. 6, in which a relation between the positions of the light-emitting element groups 204 and photosensors 230 on the glass substrate 220 is shown. A light-emitting element pattern formed on the glass substrate 220 is constructed with a first light-emitting element group row that is formed by aligning the light-emitting element groups 204 in the first row, a second light-emitting element group row that is formed by aligning the light-emitting element groups 204 in the second row, and a third light-emitting element group row that is formed by aligning the light-emitting element groups 204 in the third row. The photosensors 230 are disposed at the two sides with the light-emitting element pattern therebetween.

As shown in FIG. 7, the photosensors 1 are allocated to the light-emitting element groups 204 positioned in the area A, and the photosensors 2 are allocated to the light-emitting element groups 204 positioned in the area B. Thus, when the light-emitting elements 202 in each of the light-emitting element groups 204 are turned on one by one in the correction process, the light emitted from the light-emitting elements 202 positioned in the area A is received by the photosensors 1, and the light emitted from the light-emitting elements 202 positioned in the area B is received by the photosensors 2, so that the light amounts are detected. In this manner, the light emitted from the light-emitting elements 202 included in the first to third rows of the light-emitting element groups is received by the same sensors 230. When image forming (printing) is performed, correction on light-emitting elements 202 adjacent to each other is performed by the same photosensor 230. Therefore, in the correction process, light amount detection errors are prevented from occurring in units of adjacent light-emitting element groups 204, so that image non-uniformity in image forming (printing) is suppressed.

### Second Embodiment

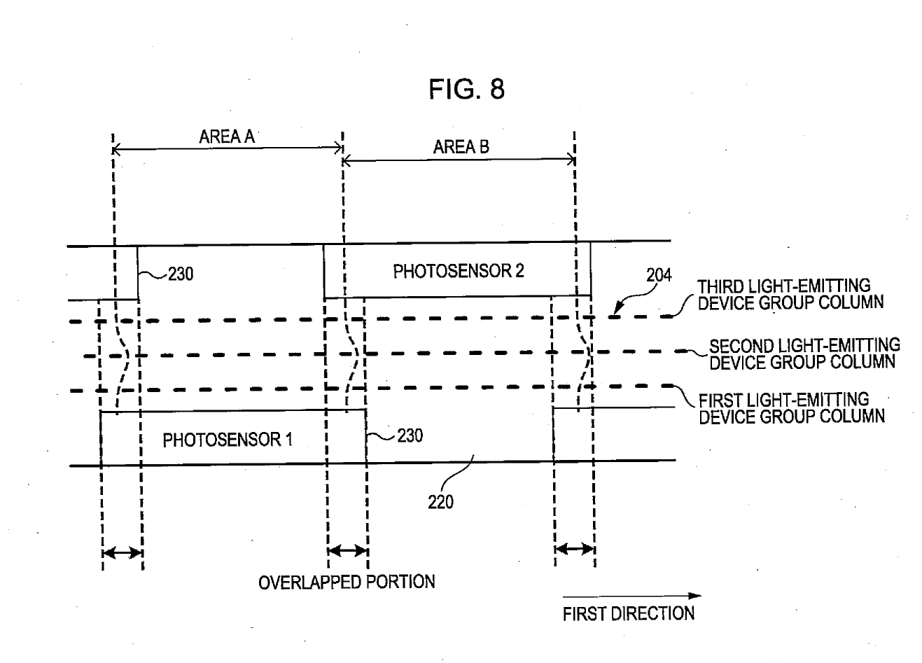

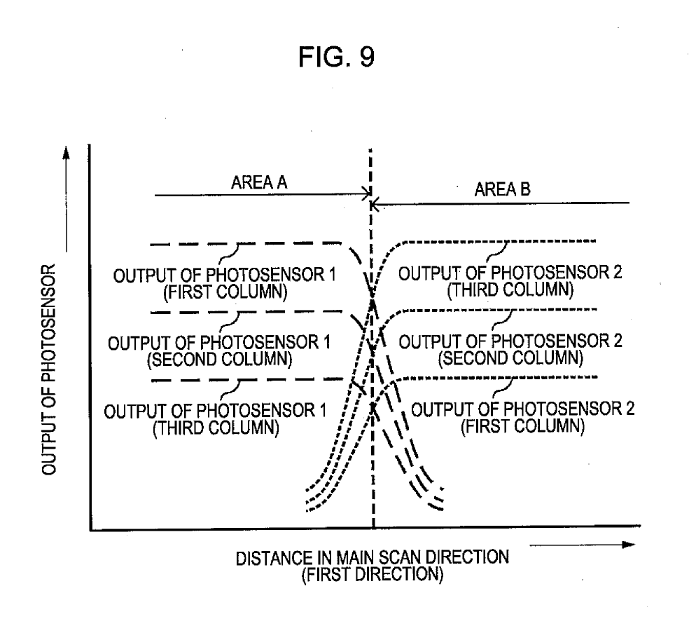

An arrangement of photosensors 230 according to a second embodiment is described with reference to FIGS. 8 and 9. FIG. 8 is a partial enlarged view of FIG. 6, in which a relation between the positions of the light-emitting element groups 204 and the photosensors 230 on the glass substrate 220 is shown. FIG. 9 is a view showing output characteristics of each of the photosensors 230 in the main scan direction (first direction). The second embodiment is different from the first embodiment in that an overlapped portion is provided between the photosensor 1 and the facing photosensor 2 with the light-emitting element pattern interposed therebetweeen.

As shown in the output characteristics of each of the photosensors 230 in FIG. 9, the output of the photosensor 1 is decreased in the order of the first, second, and third light-emitting element group rows, and the output of the photosensor 2 is decreased in the order of the third, second, and first row light-emitting element group rows. In addition, as the characteristics, although uniform output can be obtained from the central portion of the photosensor 230 irrespective of the position in the first direction, the output in the vicinity of the end portion (hereinafter, referred to as “shoulder portion”) in the first direction is decreased. In the case where the characteristic of a decrease in output from the shoulder portion, even though the same photosensor 230 is used, a light amount detection error may occur.

As the feature of the second embodiment, by taking into consideration the decrease in output from the shoulder portions of the photosensors 230, the photosensors 1 and the facing photosensor 2 are provided with portions that are partially overlapped in the first direction as shown in FIG. 8. According to the second embodiment, the shoulder portions, in which the characteristics of the photosensors 230 deteriorate, are avoided from being used, and the light amounts from the light-emitting elements 202 having a characteristic portion that is flat in the central portion can be detected. Therefore, in the correction process, light amount detection errors of the photosensors 230 in the first direction can be prevented, so that image non-uniformity in image forming (printing) is further suppressed.

### Third Embodiment

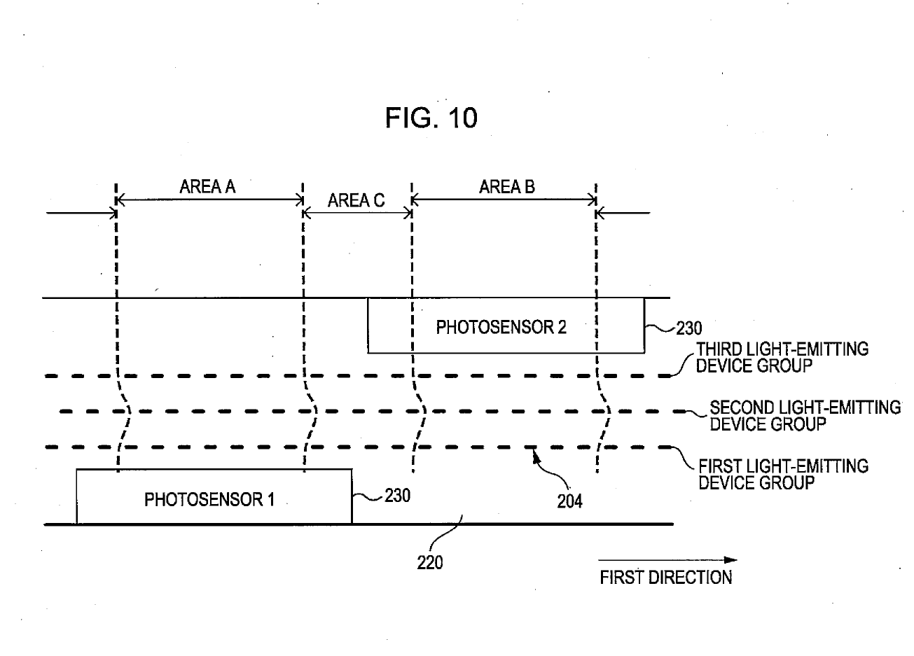

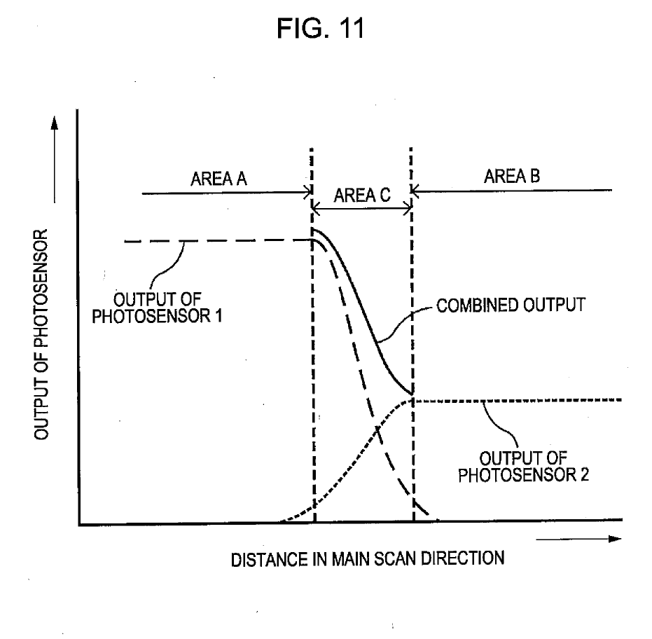

An arrangement of photosensors 230 according to a third embodiment, is described with reference to FIGS. 10 and 11. FIG. 10 is a partial enlarged view of FIG. 6, in which a relation between the positions of the light-emitting element groups 204 and the photosensors 230 on the glass substrate 220 is shown. FIG. 11 shows output characteristics of each of the photosensors 230 in the main scan direction (first direction) in the first row of the light-emitting element groups. In the first and second embodiments, the light amounts of the light-emitting elements 202 are detected by one photosensor 230. In the third embodiment, the outputs of the photosensors 230 that face each other with the light-emitting element pattern interposed therebetween and that are adjacent to each other in the first direction are combined, and the light amount is detected. More specifically, the light amounts emitted from the light-emitting elements 202 included in the area A in the central portion of the photosensor 1 and the area B in the central portion of the photosensor 2 are detected from the outputs of only the photosensor 1 and the photosensor 2, and the light amounts emitted from the light-emitting elements 202 included in the area C in the vicinity of the shoulder portions of each of the photosensors 230 are detected from a combination (addition) of the outputs of the photosensor 1 and the photosensor 2.

In FIG. 11, the output characteristics of the photosensor 1 and the photosensor 2 in the first row of the light-emitting element groups and the combined output characteristics in the area C are shown. With respect to the area C in which the output deterioration occurs in the shoulder portion, the signal intensity is increased by combining the outputs of the facing the photosensors 230. In addition, similar to the second embodiment, in the embodiment, the photosensor 1 and the photosensor 2 facing the photosensor 1 may also be partially overlapped with each other in the first direction.

### Fourth Embodiment

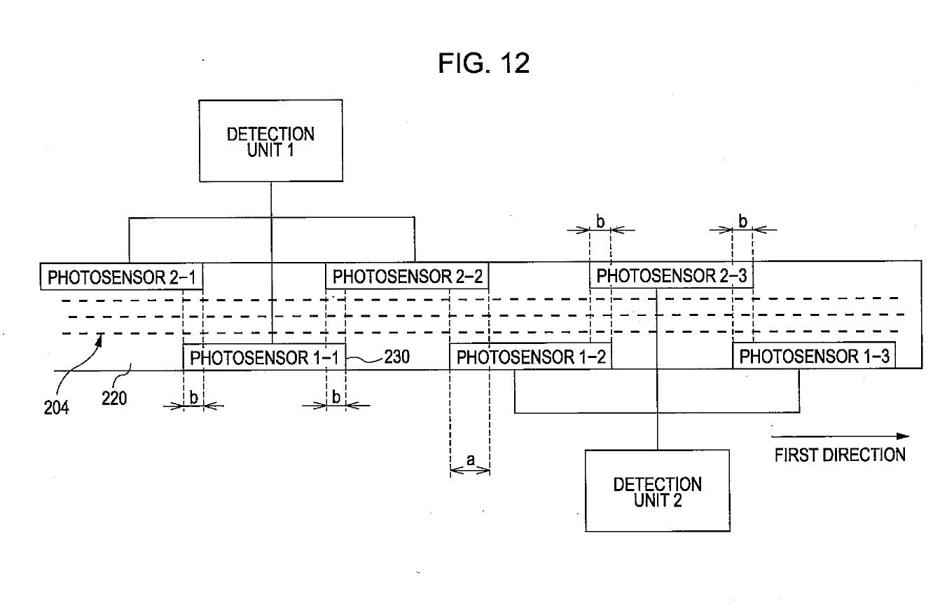

An arrangement of photosensors 230 according to a fourth embodiment is described with reference to FIG. 12. The fourth embodiment is configured by combining the second and third embodiments. In other words, with respect to the photosensors 2-1, 1-1, and 2-2 (hereinafter, referred to as a “first photosensor group”) connected to the detection unit 1 shown in FIG. 12, the shoulder portions of the facing photosensors 230 are overlapped with only the width b, and the light amount is detected from the output of each of the associated photosensors 230. Similarly, with respect to the photosensors 1-2, 2-3, and 1-3 (hereinafter, referred to as a “second photosensor group”) connected to the detection unit 2, the shoulder portions of the facing photosensors 230 are configured to be overlapped with only the width b, and the light amount is detected from the output of each of the associated photosensors 230. According to this configuration, similarly to the third embodiment, in each photosensor group, the outputs of the photosensors 230 adjacent to each other in the first direction are combined, so that the signal intensity in the shoulder portions of the photosensors 230, which has a tendency to be attenuated, is increased.

On the other hand, the first and second photosensor groups are overlapped with each other only by the width a. More specifically, the photosensor 2-2 and the photosensor 1-2 are overlapped with each other by the width a. Although the signals are not combined between the first and second photosensor groups, in the above configuration, the light amount detection of the photosensor 230 in the shoulder portion is avoided from being used, and the light amounts from the characteristic portion that is flat in the central portion can be detected, so that light amount detection errors are suppressed.

In the fourth embodiment, the overlapped widths between the photosensors preferably satisfies (width a)≧(width b). This is because, in order to combine the outputs of the photosensors 230 that are overlapped with each other by the width b, the width b can be configured to be smaller than the width a, that is, the overlapped width in the case where the signals are combined.

Various embodiments of the invention have been described. According to the exposure head employing the arrangement of the photosensors 230 in the invention, the SN ratio of the signals detected by the photosensors 230 is improved, so that light amount detection errors between adjacent light-emitting element groups in the correction process are suppressed. In addition, a small number of the photosensors 230 can be efficiently arranged, so that costs are reduced. In addition, the space between the photosensors 230 can be used to dispose circuits therein, so that a small-sized exposure head can be implemented.

While various embodiments of the invention have been described, the invention is not limited thereto, and a suitable combination of the embodiments is included in the scope of the invention.

What is claimed is:

1. An exposure head comprising:
a light-transmitting substrate;
a first light-emitting element row that is formed by disposing light-emitting elements in a first direction on the light-transmitting substrate;
a second light-emitting element row that is formed by disposing light-emitting elements in the first direction and that is different from the first light-emitting element row;
a first photosensor that is disposed at a first side in a second direction perpendicular to the first direction on the light-transmitting substrate to receive light emitted from the light-emitting elements of the first and second light-emitting element rows;
a second photosensor that is disposed in the second direction at a second side opposite to the first side on the light-transmitting substrate to receive light emitted from the light-emitting elements of the first and second light-emitting element rows; and
an image-forming optical system that forms an image with the light emitted from the light-emitting elements.

2. An exposure head comprising:
a light-transmitting substrate;
a first light-emitting element row that is formed by disposing light-emitting elements in a first direction on the light-transmitting substrate;
a second light-emitting element row that is formed by disposing light-emitting elements in the first direction and that is different from the first light-emitting element row;
a third light-emitting element row that is formed by disposing light-emitting elements in the first direction and that is different from the first and second light-emitting element rows;
a first photosensor that is disposed at a first side in a second direction perpendicular to the first direction on the light-transmitting substrate to receive light emitted from the light-emitting elements of the first, second and third light-emitting element rows;
a second photosensor that is disposed in the second direction at a second side opposite to the first side on the light-transmitting substrate to receive light emitted from the light-emitting elements of the first, second and third light-emitting element rows; and
an image-forming optical system that forms an image with the light emitted from the light-emitting elements.

3. The exposure head according to claim 1 or claim 2, wherein the first and second photosensors are partially overlapped with each other as viewed from the second direction.

4. An image forming apparatus comprising:
an exposure head including a light-transmitting substrate, a first light-emitting element row that is formed by disposing light-emitting elements in a first direction on the light-transmitting substrate; a second light-emitting element row that is formed by disposing light-emitting elements in the first direction and that is different from the first light-emitting element row, a first photosensor that is disposed at a first side in a second direction perpendicular to the first direction on the light-transmitting substrate to receive light emitted from the light-emitting elements of the first and second light-emitting element rows, a second photosensor that is disposed in the second direction at a second side opposite to the first side on the light-transmitting substrate to receive light emitted from the light-emitting elements of the first and second light-emitting element rows, and an image-forming optical system that forms an image with the light emitted from the light-emitting elements;
a latent image container on which a latent image is formed by the exposure head; and
a developing unit that develops the latent image formed on the latent image container.

5. An image forming apparatus comprising:
an exposure head including a light-transmitting substrate, a first light-emitting element row that is formed by disposing light-emitting elements in a first direction on the light-transmitting substrate, a second light-emitting element row that is formed by disposing light-emitting elements in the first direction and that is different from the first light-emitting element row, a third light-emitting element row that is formed by disposing light-emitting elements in the first direction and that is different from the first and second light-emitting element rows, a first photosensor that is disposed at a first side in a second direction perpendicular to the first direction on the light-transmitting substrate to receive light emitted from the light-emitting elements of the first, second and third light-emitting element rows, a second photosensor that is disposed in the second direction at a second side opposite to the first side on the light-transmitting substrate to receive light emitted from the light-emitting elements of the first, second and third light-emitting element rows, and an image-forming optical system that forms an image with the light emitted from the light-emitting elements;
a latent image container on which a latent image is formed by the exposure head; and
a developing unit that develops the latent image formed on the latent image container.
